(19) United States
(12) Patent Application Publication
(10) Pub. No.: US 2007/0299851 A1
(43) Pub. Date: Dec. 27, 2007

(54) Interoperable public and proprietary web accessible database and data brokerage

(75) Inventor: Theodore S. Kalbfleisch, Louisville, KY (US)

Correspondence Address: GREER, BURNS & CRAIN, 300 S WACKER DR, 25TH FLOOR, CHICAGO, IL, 60606, US

(73) Assignee: University of Louisville Research Foundation

(21) Appl. No.: 11/809,410

(22) Filed: Jun. 1, 2007

Related U.S. Application Data
(60) Provisional application No. 60/810,796, filed on Jun. 2, 2006.

(51) Int. Cl. G06F 17/30

(52) U.S. Cl. 707/10; 707/E17.001

(57) ABSTRACT

A preferred embodiment system provides a secure repository for researchers' data. The system also supports the sharing of proprietary and draft data amongst collaborators. The system provides for brokerage service for the submission to and collection of data from production facilities. Additionally, the system provides web based advertising of context relevant assays, chips, etc., and supports direct ordering of these assays through the system.

### REFERENCE TO RELATED APPLICATION AND PRIORITY CLAIM

This application is related to and claims priority from prior co-pending provisional application Ser. No. 60/810,796, filed Jun. 2, 2006, and entitled Interoperable Public and Proprietary Web Accessible Database and Data Brokerage.

### FIELD

A field of the invention is databases and data management and, particularly, life science databases and database management.

### BACKGROUND

Life sciences researchers are confronted with problems that extend beyond information management. In addition to the need to manage discovered information, the discovery process itself must be managed along with the information associated with the discovery process. Life science research tools include a patchwork of public access and fee based tools. Researchers typically make use of unrelated tools, and spend significant time and effort managing the discovery process and the information obtained from the discovery process. Particular tools typically advance a particular platform or business interest, but information exchange and interoperability are limited. Data and project management are constant problems in today's research environment, yet researchers are reluctant to pay for software to address these needs.

Software and databases exist to allow browsing and mining of genomic databases, and that permit researchers to submit data for integration into larger datasets. Genbank is an example, but once data is placed in the database, it becomes publicly available.

Applied Biosystems provides software that allows researchers to look through data and order assays through the system. Researchers are provided with public domain information. During browsing of this information, researchers are given context specific suggestions.

Curagen provides an exemplary typical bioinformatics infrastructure called GeneScape®. This portal can be used to manage, interpret, and translate genomic data. Researchers can utilize data from a number of genomic technologies provided by Curagen. The also allows incorporation of public or private data. Unified discovery linking together various laboratories and departments is provided. Samples and data can be tracked.

In both the corporate and academic biotechnology research environments, much of the data generation that is done, is done as fee for service work by external service providers. These external facilities provide services spanning genomic, proteomic, and metabolomic research areas, with manifold technologies within each for performing low throughput, high throughput (small numbers (10s) of samples against a large number of assays) to ultra high throughput (large numbers of samples (100s to thousands of samples) against a large number of assays) analyses. These technologies include Sanger based sequencing, for sequencing and genotyping work, mass spectrometry for genotyping, proteomic and metabolomic analysis, a variety of whole genome technologies such as microarrays, and bead based technologies which can be used for genotyping, or expression analysis, and the emerging technologies which will provide economically viable whole genome sequencing.

Researchers are reluctant to use typical informatics databases as an actual integrated research tool. While information can be obtained, and certain services and data acquired, researchers are reluctant to place draft data into a system and use it as an integrated research tool combining their own efforts with the data and services that can be extracted from typical commercial portals.

### SUMMARY OF THE INVENTION

A preferred embodiment system provides a secure repository for researchers' data. The system also supports the sharing of proprietary and draft data amongst collaborators. The system provides for brokerage service for the submission to and collection of data from production facilities. Additionally, the system provides web based advertising of context relevant assays, chips, etc., and supports direct ordering of these assays through the system.

### BRIEF DESCRIPTION OF THE DRAWINGS

FIG. 1 shows an example embodiment system of the invention;

FIG. 2 illustrates interactions of the server of FIG. 1 with a provider system;

FIG. 3 illustrates a screen in a preferred graphical user interface for the discovery browser for the registration of research subjects;

FIG. 4 illustrates another screen in a preferred graphical user interface for the discovery browser for the entry of samples taken from the subjects described FIG. 3;

FIG. 5 illustrates another screen in a preferred graphical user interface for the discovery browser for the upload of data on specific aliquots of the samples described in FIG. 4 on which experiments would be run;

FIG. 6 illustrates another screen in a preferred graphical user interface for the discovery browser that allows a researcher to manually create the same experimental samples described in FIG. 5;

FIG. 7 illustrates another screen in a preferred graphical user interface for the discovery browser for the creation of an experiment in which specific tests are requested to particular experimental samples, a so called production job;

FIG. 8 illustrates another screen in a preferred graphical user interface for the discovery browser for the creation of the individual test/experimental sample requests (a production task) that constitute the production job;

FIG. 9 illustrates another screen in a preferred graphical user interface for the discovery browser which allows a researcher to queue their experiment, a production job, to a participating provider;

FIG. 10 illustrates another screen in a preferred graphical user interface for the discovery browser that allows an independent researcher to upload single nucleotide polymorphism and genotype data to the system;

FIG. 11 illustrates another screen in a preferred graphical user interface for the discovery browser in which uploaded genotype data is displayed;

FIG. 12 illustrates another screen in a preferred graphical user interface for the discovery browser from which validated assays may be purchased from a participating provider;

FIG. 13 illustrates another screen in a preferred graphical user interface for the discovery browser from which a user may request a custom assay design from a participating provider.

### DETAILED DESCRIPTION OF THE PREFERRED EMBODIMENTS

An embodiment of the invention provides a tool for facilitating comprehensive, collaborative research in the life sciences. The tool includes a repository where researchers may store and share their data such that it will be integrated with data available within the public domain and may be viewed by any collaborating researcher with appropriate permissions. A security model and implementation allows researchers to grant access permissions to collaborators such that the data can be shared in a tightly controlled manner. A brokerage service between the researcher and participating service and/or materials (such as assays) providers allows easy and streamlined access to and ordering from the providers. An interface allows researchers to enter samples, to couple. them with known tests, and queue these experimental projects to the provider. A repository for the data that is generated by the service provider is provided, integrating the data with the other data available to the researcher in the discovery system. An interface permits reagent vendors to submit assays to be mapped within the system, so that when a researcher looks at features of interest, they will be able to see what assays may be available to them for order. An interface permits companies that provide assay synthesis services such that any assay that is designed within the system can be submitted directly for synthesis. An interface permits companies that provide software for analyzing life sciences data, SAS (SAS is a statistical analysis software package that is an industry standard for analyzing laboratory and clinical research data) and the like, permitting companies to design application programming interfaces to interoperate with the system directly.

A system of the invention provides a secure central repository and research tool that encourages free collaboration among joint researchers, simplifies commercial service and data acquisition. System security permits secure data sharing, and allows the placement of both draft and otherwise proprietary data. A system of the invention is a research tool that can act as a proprietary research database, while also permitting researchers, within the system, to order context specific bio and genomic goods and services from a variety of providers. Orders are placed within the primary research system. When data is the product being ordered, it is provided back to the researcher through the system. A point of sale is, essentially, integrated in the researcher's notebook.

Preferred systems are implemented over a network. Closed and open networks can be used in different embodiments. Example embodiments will be illustrated with a web accessible system, but artisans will appreciate that other wide area and local area network implementations are within the scope of the invention.

An embodiment of the invention provides a web services based system that supports collaborative life sciences research. The preferred system makes use of services, tools and assays existing within the life sciences, and provides an interface and backbone to make them function as an integrated whole. Embodiments of the invention permit proprietary data to be stored and accessed securely for collaborations, and also permits sharing of public information and results.

Preferred embodiment systems and methods of the invention provide web based life sciences data management, where researchers are provided with a secure location for the storage of their proprietary or draft genomic, proteomic, and metabolomic data. Such data can be integrated into the larger context of all data, both public domain as well as proprietary that is available to the researchers. The preferred embodiment system provides a browser as an interface, and tools for accessing, mining, and analyzing the data stored within the database maintained by the system.

Preferred embodiment systems of the invention provide a data brokerage service, through which researchers can design experiments, and submit them to production core facilities or commercial service providers. Data generated by these production facilities is returned to the researchers through the system, relieving the researchers and the production facility or commercial service providers from the burden of the formatting and parsing issues that accompany these sorts of interactions. Preferred embodiment systems can also provide a method for production facilities and commercial providers to bid for work. Additionally, preferred embodiment systems can provide for researcher and context directed advertising, e.g., for advertising context specific assays through the system's browser.

A preferred embodiment system provides free researcher access, and a fee (e.g., a straight percentage) is charged to a provider/production facility for all transactions brokered through the system. A system of the invention can also serve as the interface between reagent and service providers. Point-of-sale is effectively moved directly into the researchers notebook, making it possible for commercial providers to market their products and services with great accuracy.

A preferred embodiment system provides a secure repository for researchers' data. The system also supports the sharing of proprietary and draft data amongst collaborators. The system provides for brokerage service for the submission to and collection of data from production facilities. Additionally, the system provides web based advertising of context relevant assays, chips, etc., and supports direct ordering of these assays through the system.

Preferred embodiment systems and methods will now be discussed with respect to the drawings. Artisans will recognize that various coding strategies, network architectures, operating systems, etc. can be used to implement systems and methods of the invention. From the description of the preferred embodiment systems and methods, artisans will recognize broader aspects and additional features of the invention.

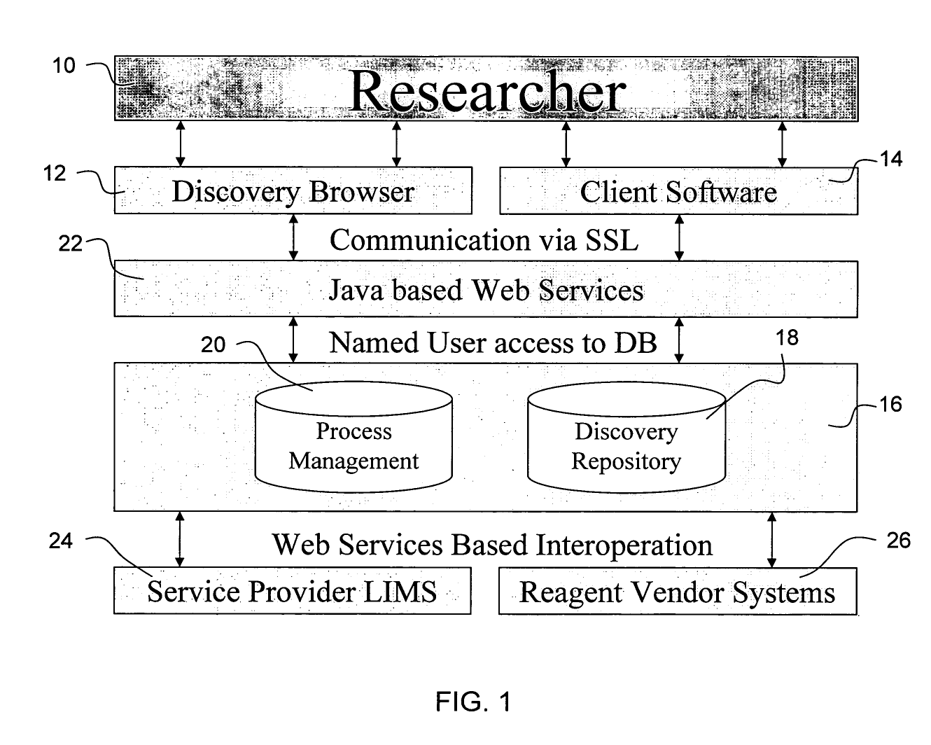

FIG. 1 shows an example embodiment system of the invention. Intuitive user interfaces support manual interaction with the system by the researcher. A researcher client computer 10 provides a researcher with access to the system through an interface 12. The client computer 10 is typically a desktop computer, such as a stand alone computer or a computer that is member of a local area or wide area network. Client software 14 runs on the client computer 10 or a network associated with the computer and handles communications and back ground operations for the system to interact with the client computer. Preferably, application programming interfaces (APIs) for a web service are published, and researchers are encouraged to access the system via these APIs. A data browser is a preferred application interface 12. Interactions with participating service providers and vendors are conducted through the web service.

An important incentive for a researcher to use the system is secure storage of the researchers data, along with a bundling of functionality to aid the researcher. A secure server 16 provides individualized and protected storage for each researcher that makes use of the system in a database 18 referred to as a discovery repository. All aspects of process, such as the queuing of experiments to production facilities, retrieval of the data produced, and order for reagents or data are managed by the process management subsystem 20. Security for storage of data, private collaboration, access to providers, such as service providers and reagent vendors is managed within the discovery repository 18 in the server. In preferred embodiment, access to the database 18 via the web service, or via direct access, is conducted only by named users. In the FIG. 1 system, access is through Java based web services 22 that provide an SSL access to the database 18. In preferred embodiments, the server 16 implements both row and role level access to data. In an example embodiment, row level access is implemented via database views utilizing object dependent access tables. Grant access is also limited via roles, for example, to distinguish researchers from administrative users.

The server 16 also accesses and/or is also accessible to outside providers. Outside providers include, for example, public data collections, service providers, vendors, etc. In FIG. 1, a service provider Laboratory Information Management System 24 provides APIs germane to the services it provides, to the server 16. Process manager 20 intelligently associates particular relevant services of the service provider 24 with data sets in the database 18 such that tests provided by the service provider may be requested and run. Similarly, process manager 20 intelligently associates particular assays of a reagent vendor 26 with data sets in the database. A researcher using the system will therefore see, such as through a pull down menu, services and assays applicable to the data that the researcher has stored. Additionally, the server 16 provides an ordering capability so that the researcher can order services and assays while viewing the researcher's data.

An example research endeavor will illustrate some functionality of a preferred embodiment system of the invention. A typical genomics experiment is considered. Researcher A is interested in schizophrenia decides upon genomics analysis of subjects from tissue registry for marker discovery project. Researcher A consults with biostatistician regarding experimental design. Based upon this design, a whole genome scan is performed using microarray technology. The data is analyzed by biostatisticians, and a list of transcripts whose expression levels differ significantly between the diseased and healthy populations is compiled. The research continues with the design and order primers for RT-PCR experiment for validation of the microarray results. Primers are designed using some primer design tool. Test primers are designed for specificity using in-silicon PCR tools. Primers are ordered and validation experiments conducted. The researcher may also look up gene based data, follow up with a SNP (single nucleotide polymorphism) search, look for assays for useful SNPs, and perform de-novo sequencing where necessary

Managing this process and the information produced by the above typical effort is formidable for any more than a handful of genes and subjects. Systems and method of the invention relieve investigators of the burden of process and data management to permit them to more effectively expend on those problems that require their expertise, experience, and intuition.

A preferred system of the invention integrates available information, including, for example, researchers' draft data, public domain data, and proprietary data to which the researcher has access. The system facilitates collaboration, enabling secure sharing of information with collaborating scientists. The system also provides interoperation with all services, e.g., Primer Design/Ordering, Sequencing Reagent/Service providers, and Genotyping Reagent/Service Providers. The system handles the context specific suggestion, advertising, ordering of services, and delivery of data.

A feature of a preferred embodiment system is programmatic access to data for the bioinformatics and scientific programmer. Manual interaction with the system is both necessary and important, however this type of interaction through user interfaces often proves a rate limiting step in large scale projects and the system accomplishes many of the tasks the facilitate research, collaboration, and acquiring of services and data.

The FIG. 1 preferred embodiment system is preferably sponsored by providers, for example, production facilities and analytical data providers. The tool is free to researchers, and reduces the steps for submitting data to, and retrieving data from a service provider to a trivial operation for the researcher. It also provides targeted marketing for reagent providers, who, in a preferred business model embodiment, pay a percentage fee for any transaction performed through the system, e.g., a 3% fee to the service provider on the pre-tax invoiced charge to the researcher/customer.

Preferred embodiment systems are technology agnostic, and do not promote one platform or technology over another. Systems of the invention provide researchers with immediate access to assays that are relevant to their research, and provide them with the mechanism to order the assays within the same system. Researchers can also construct experimental projects, and submit them directly to participating service providers. In preferred systems of the invention, researchers do not have to export or format the data for submission, as the system will handle the submission, and also handle the collection of data when a data service provider has completed a project. For services, all transactional and financial aspects of the service transaction can also be handled seamlessly within the system.

Preferred embodiment systems provide access to all publicly available genomic, proteomic, and metabolomic life science data, from which researchers will be able to design experimental projects (the coupling of samples to tests provided by service operations), and submit these projects as work requests to production facilities. Some examples (genomic) include the human genome sequence, sequence tag sites, polymorphism data, known genotype data, and the assays that generated them. The researcher, whether a lone PI, or a large research organization, will be able to securely enter their data, such that it is integrated with the vast amount of publicly available life sciences data. They will also have the benefit of having the newly generated data returned to the same system.

The Database 18 and Security

The database 18 is a repository permitting researchers to securely store and share data such that it will be integrated with data available within the public domain and may be viewed by any collaborating researcher with appropriate permissions.

Security implemented in the database 18 allows researchers to grant access permissions to collaborators. Within the security model described herein, a two step process has been created in order that a researcher or their proxy can grant broader access to their data. In order to maintain tight control on data access, it is reasonable to require that only the user who created the record will be permitted to update the record, or assign user group access to the sample. This, however, presents a problem. For example, if a lab director enters a record, they may want to grant permissions to update, and grant access to the record to a trusted laboratory member. If this privilege were restricted only to the record's creator, then this would be impossible. As such, the system preferably permits other users to identify other trusted users, so-called proxies, within the system who can perform these tasks. The process by which a researcher, or their proxy, will preferably has two steps, a grant step, and an approval step.

In the grant step, the records to which access will be granted are identified, and are associated with those user groups to whom the access will be provided. These records are then queued for the approval of the researcher who created/owns the records. This researcher will then acknowledge and approve the access modifications to the data set, at which point, the changes will be made.

An example implementation of the database 18 and its security on the MySQL database version 5.0 will be discussed. It is a model that can be ported to Oracle with some modification. Artisans will recognize that other operating systems and coding strategies can be used.

The example implementation includes a security model with a relational database. Researchers can securely enter data into the system, and grant row level access to their data. This makes it possible for researchers to integrate their data into the larger context of all the information available to them (including all public domain data), and still maintain the proprietary nature of their data until they decide to share the data with other select researchers, scientific agencies, publishers, other persons or groups, or the public at large.

In this scheme for implementing row level access, direct access to tables is not granted to any user other than the schema's administrator. All selects are done through views, and all inserts, updates, and deletes would be accomplished through stored procedures.

This model uses a group of 4 tables. The first of these is the user table:

User Table

CREATE TABLE user_tab
(user_id INT NOT NULL AUTO_INCREMENT,
/*The user_id is the primary key for this table.
*/
user_name VARCHAR(20) UNIQUE NOT NULL,
/*The user_name should be a unique field for a variety of reasons,
chief among them is
**the fact that there should be no ambiguity amongst users
*/
date_created DATE NOT NULL,
created_by INT NOT NULL,
date_updated DATE,
updated_by INT,
/*This table maintains the list of users who are authorized to retrieve, add
and modify
** records within the system. Therefore, the created_by and modified by
fields in all
** tables (including this one), must reference a record in this table. These
constraints
** make certain that the user who creates a record in this table, has a
corresponding user ** record within it.
*/
FOREIGN KEY (created_by) REFERENCES user_tab(user_id),
FOREIGN KEY (updated_by) REFERENCES user_tab(user_id),
PRIMARY KEY (user_id)) ENGINE=INNODB;
/* INNODB is the storage engine that supports the commits, and rollbacks
required for ** the transaction model described here. It also provides
support for foreign key ** constraints.
*/

One constraint for this model that must be enforced as policy as opposed to explicitly within the database, is the fact that an active user must have a record within the mysql.user table. The constraint between the two is that there must be a record in the mysql.user table where value in the user column is equal to the value of the user_name column for the corresponding record in the user_tab. The get_user_id depends upon this relationship.

The get_user_id function will return the discovery system user id for the current user. This function was created by the root user when the create scripts were run, and they will be executed with their privileges.

```
DROP FUNCTION IF EXISTS get_user_id;
delimiter //
CREATE FUNCTION get_user_id ( )
RETURNS INT
SQL SECURITY DEFINER
BEGIN
DECLARE userId INT;
  SELECT user_id INTO userId
  from user_tab
  where user_name = USER( );
RETURN userId;
END;
//
delimiter ;
```

Although no user other than the admin user will have the privilege to execute it, it will be called within most all stored procedures for the purpose of identifying the user who is executing the stored procedure, and using this identifier wherever it is required.

User Group Table

The second of the tables in this security model is the
user_group_tab.
CREATE TABLE user_group_tab
(user_group_id INT NOT NULL AUTO_INCREMENT,
user_group_name VARCHAR(20) UNIQUE NOT NULL,
primary_user_group BOOLEAN NOT NULL DEFAULT false,
date_created DATE NOT NULL,
created_by INT NOT NULL,
date_updated DATE,
updated_by INT,
FOREIGN KEY (created_by) References user_tab(user_id),
FOREIGN KEY (updated_by) References user_tab(user_id),
PRIMARY KEY (user_group_id)) ENGINE=INNODB;

The user_group_tab is a table for creating logical user groups. For this particular model, each user within the system is required to belong to what is designated a primary user group. A primary user group is a user group that contains one and only one user. The reason for this is that, in this model, every piece of data must be associated with the primary user group of the user who created the data record.

Other logical groups that would be created are, one corresponding to a research group, one corresponding to a department, one corresponding to an enterprise, and, perhaps, one corresponding to all users or a public user group. Important things to note regarding this table, are the unique constraint on the user_group_name, and the foreign key constraints to the user table for both created_by, and updated_by columns.

User Group User Table

Now that there are tables that define users and user groups, another
table is required so that users can be associated with these groups. The
third table in the set of four is the user group user table.
CREATE TABLE user_group_user_tab
(user_group_user_id INT NOT NULL AUTO_INCREMENT,
user_group_id INT NOT NULL,
user_id INT NOT NULL,
UNIQUE INDEX (user_id, user_group_id),
date_created DATE NOT NULL,
created_by INT NOT NULL,
date_updated DATE,
updated_by INT,
FOREIGN KEY (user_id) REFERENCES user_tab(user_id),
FOREIGN KEY (created_by) REFERENCES user_tab(user_id),
FOREIGN KEY (updated_by) REFERENCES user_tab(user_id),
FOREIGN KEY (user_group_id) REFERENCES
user_group_tab(user_group_id),
PRIMARY KEY (user_group_user_id)) ENGINE=INNODB;

This table is a linking table whose job it is to associate users with user groups. A feature to note here, is the unique index on the user_id, and user_group_id fields. This index serves two functions, the first is to make certain that a user is not placed in the same user group more than one time, a preferable but not critical benefit. The second benefit is the creation of an index. Indices greatly improve the performance of select statements on large data sets. The user_id is a good column on which to create an index as it is the column that will be most frequently joined in this table.

User Group Feature Table

A fourth table is a table (or more appropriately a type of table) that
will establish what pieces of data user groups may access. For this
example, a table will be created that provides user group access to the data
in the feature table.
CREATE TABLE user_group_feature_tab
(user_group_feature_id INT NOT NULL AUTO_INCREMENT,
user_group_id INT NOT NULL,
feature_id INT NOT NULL,
UNIQUE INDEX (user_group_id, feature_id),
date_created DATE NOT NULL,
created_by INT NOT NULL,
date_updated DATE,
updated_by INT,
FOREIGN KEY (created_by) REFERENCES user_tab(user_id),
FOREIGN KEY (updated_by) REFERENCES user_tab(user_id),
FOREIGN KEY (feature_id) REFERENCES feature_tab(feature_id),
FOREIGN KEY (user_group_id) REFERENCES
user_group_tab(user_group_id),
PRIMARY KEY (user_group_feature_id)) ENGINE=INNODB;

The function performed by this table is the specific designation of what feature records a user group may access. A table of this type would be created for every object, i.e., a gene, transcript, or SNP whose access must be explicitly controlled. This table is what will be used by the database view that will provide the researcher with access to the data in any given table.

The create statement for the view that will implement the row level security so far described is as follows

CREATE OR REPLACE VIEW feature
SQL SECURITY DEFINER
AS SELECT DISTINCTROW feature_tab.*
FROM feature_tab f, user_group_feature_tab ugf,
user_group_user_tab ugu
WHERE ugu.user_id = get_user_id()
AND ugf.user_group_id = ugu.user_group_id
AND f.feature_id = ugf.feature_id;

When selected against as “select * from feature”, this view will return all data associated with each feature record to which the invoking user has been granted access through the user_group_feature_tab. Therefore, if a user with the appropriate permissions would like to grant access for a collaborator, or a collaborating group, to their feature data, all that is necessary is an insert of the appropriate user group identifiers into the user group_feature_tab, and the data will be accessible through the view. Note the call to the system function get_user_id( ) in the first line of the where clause. This is yet another feature that must be supported by the database in order to implement security within the database. The mysql function user( )will return the system user name of the user who is invoking the view. This is the function that makes any of this possible since this model depends upon the ability to know exactly who is trying to access or modify any piece of data. Also, note the line “SQL SECURITY DEFINER”. With this specification in place, the view will be executed under the privileges of the user who defined the view. This too is very important, since it is desirable to deny all access to these security tables for all users but the admin user who will be creating the tables, views, and stored procedures. Thus select access can be granted on this view to a researcher, and the view will be able to gain the necessary access to the security tables, tables whose access is forbidden to the invoking researcher.

Discovery Browser 12 and Process Management 20 for Polymorphism

The process manager 20 can accept and handle polymorphism polymorphism data submitted by a researcher for storage in the database 18 and information provided back to the researcher via the discovery browser 12. This process outlined here has similarity that used by the government run dbSNP (single nucleotide polymorphism database), but the present database 18 is preferably updated on a daily or more frequent basis. The frequent updating will allow researchers to submit their SNP data, and quickly learn if those SNPs are novel, or if they have been identified in any other external research efforts to which they have access (such as those records in dbSNP). The SNP data will also be mapped immediately to either its species specific genome or transcriptome such that neighboring SNPs may be identified and compensated for in assay designs.

In the process, a SNP is submitted into the database 18 by a researcher. It is mapped via sequence similarity to SNP datasets already in the system. If it matches, then it is associated with the existing SNP, and if not a new SNP is created in the system. When a new SNP is created, the DNA type is checked it is either mapped to transcripting or to genome based upon the DNA type

Brokerage Service Through Discovery Browser 12

The system of the invention provides a data specific brokerage service to greatly simplify a researcher's efforts at locating specific services and products concerning data that they store in the database 18. The browser 12 preferably presents the brokerage service between the researcher and participating service provider to the researcher via product and services selections and advertising that is specific to the data that they have entered or are viewing. For example, when a researcher inputs a particular SNP, the researcher, such as through a pull down menu, will see assays or services of participating providers that are relevant to the data that is being entered or viewed. Ordering is then simplified to a direct selection of a desired product or service, and there is no need to make note of, search for, and use separate interfaces to obtain the product or services. Additionally, the server 16 preferably keeps track of the association and ordering history in a relational manner for data in the database and products/services that have been viewed and/or ordered. A researcher can than pull up recently viewed products and services, for example, to complete an order process or access the data that the products and services related to.

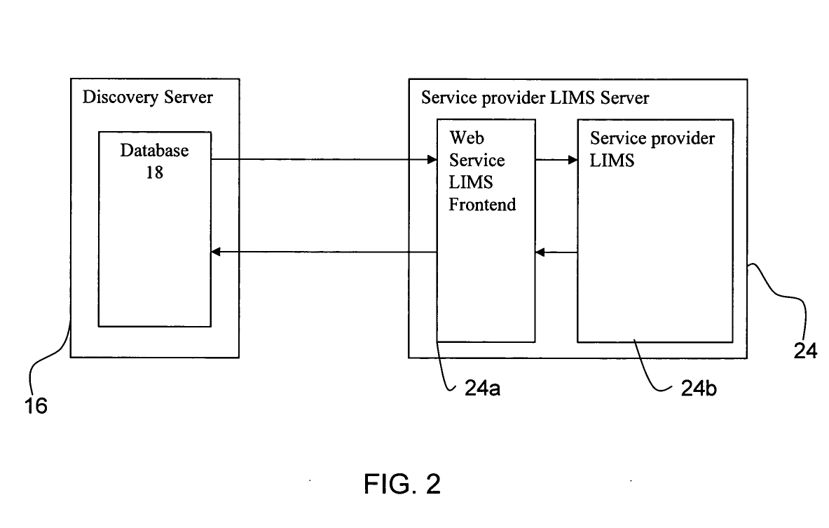

As an example, a laboratory information management system (LIMS) that can to interoperate with any external service provider will be discussed. As seen in FIG. 2, the server 16 accesses the LIMS 24 through a front end of the service 24a. The front end has be set up to work with the server 16, for example, by a sponsoring service provider that wishes to market its services to researchers using the database 18.

In this example, the web service front end for the LIMS 24a is capable of interoperating with the server 16. With such a model, it is unnecessary to modify the server 16 to suit the particular formats requirements or APIs of the many different participating service providers. Because the LIMS front end 24a is capable of translating between the data model used by the server 16, and the service provider LIMS 24b, it is possible for the server 16 to interoperate with the Service provider via standards supported by the front end, such as the MIAME standard (minimal information about microarray experiments) regardless of whether their LIMS is equipped to handle them. Providers have an incentive to create or accept a front end 24 to communicate with the server 16 as the server 16 provides marketing and sales support to the providers. A purchase can be made by a researcher through the browser 12 using the server 16. A flat fee, e.g., 3%, is charged to the provider and the provider is given sufficient information to complete the transaction, e.g., required data, and instructions on who or where to provide the product/or service.

Through the browser 12, an interface is provided to allow researchers to enter samples, couple them with known tests, and queue these experimental projects to providers. At their most basic level, experiments are tests performed upon experimental samples. The browser 12 and system in general permit researchers to design and create experiments that can then be queued to a participating service core or commercial service provider. This coupling of experimental samples with tests defines a production task.

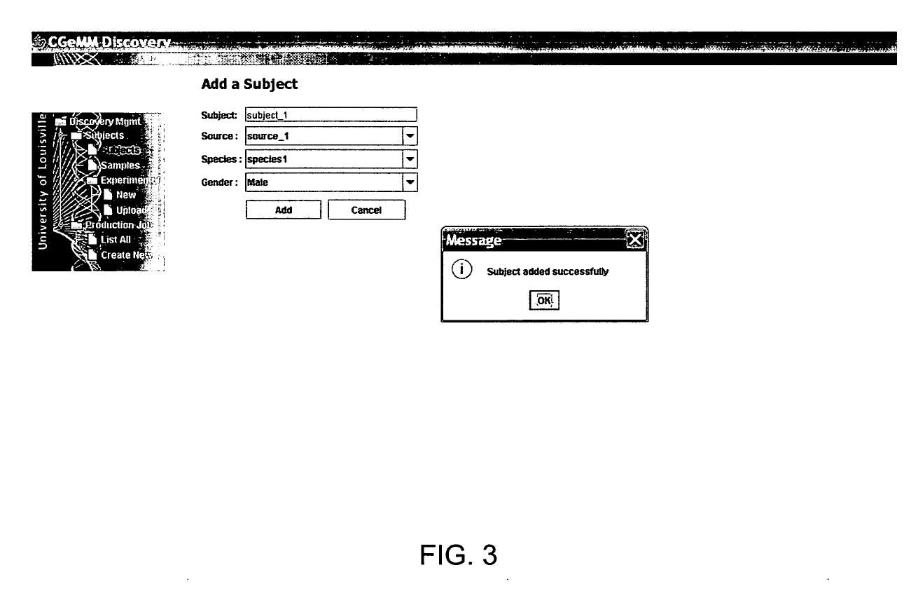

Some examples will be shown to illustrate browser functionality. Steps are discussed with preferred graphical user interfaces presented to the researcher via the browser 12. The screen shots are shown in FIGS. 3-3

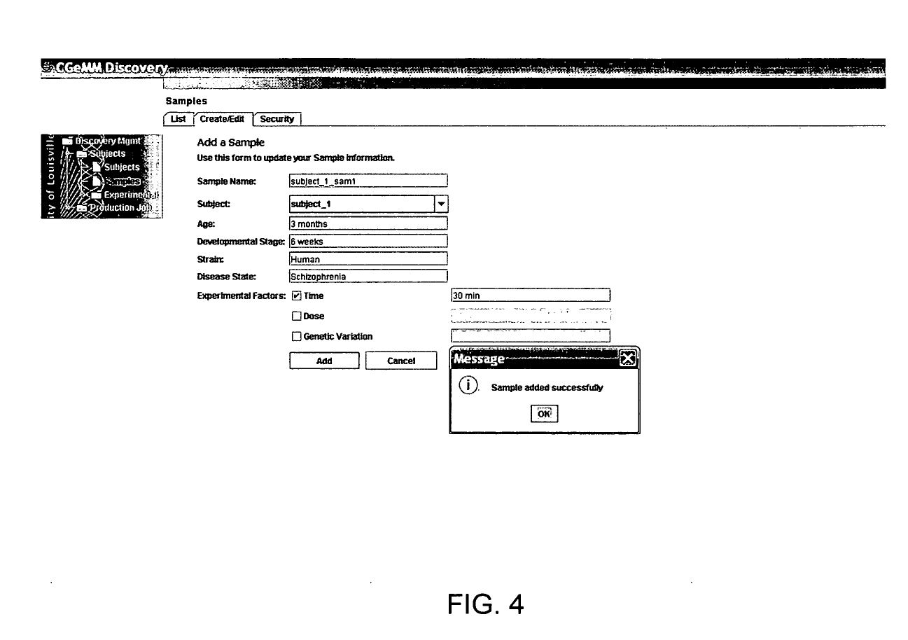

In FIG. 3, the object model of the example embodied requires that information be entered first for a subject. The researcher enters a subject in a subject field 30, and chooses from pull down menus for the subject's source, species and gender. As seen in FIG. 4, after a subject has been created that subject becomes accessible via a pull down menu, and samples can be entered for that subject. Sample name, age, developmental stage, strain, disease state, and experimental factor fields and menus are provided to the researcher.

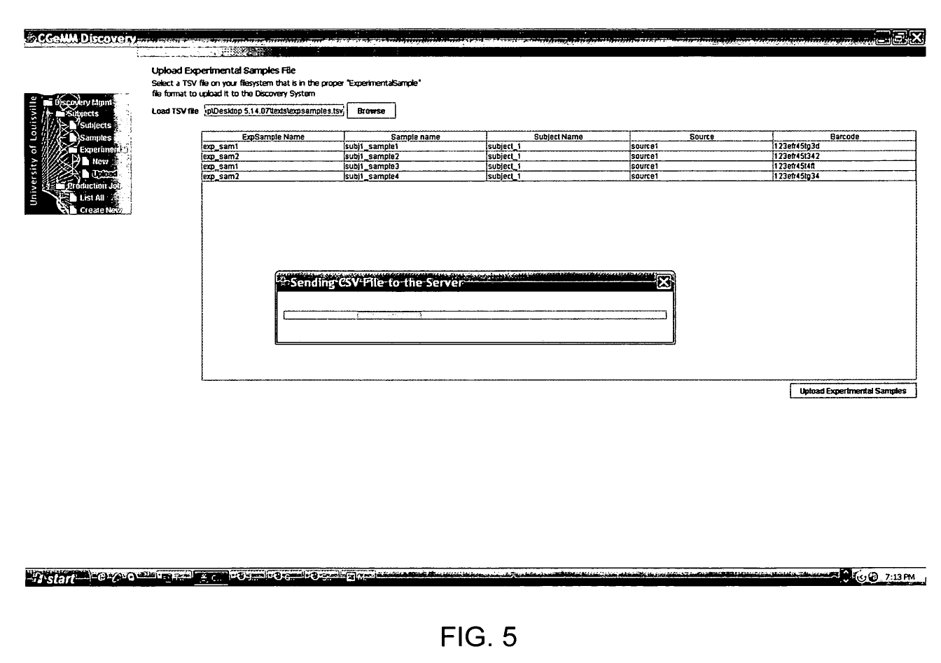

In the example discussed here, an experiment is to be performed on an aliquot of this sample. As such, an interface has been developed to create an experimental sample, which represents an aliquot of a sample, but is flexible enough that two or more samples can be pooled to create and experimental sample, as seen in FIG. 5. In FIG. 5, a table of samples can be uploaded to the server 16 via the browser 12 by the researcher with identifying data and barcodes. The table permits researchers to upload experimental sample information from a file.

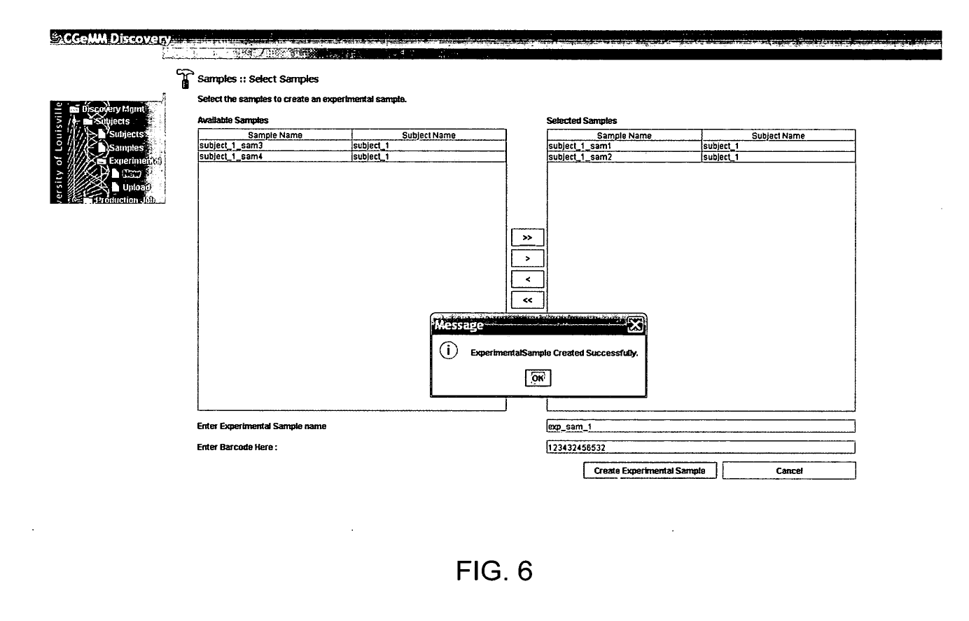

The example embodiment browser also provides an interface, as seen in FIG. 6, to enable researchers to create experimental samples from existing samples. Two tables are provided. An existing sample table gives a researcher samples available for experiments. The available sample can be moved into a selected samples table to initiate an experiment on selected samples.

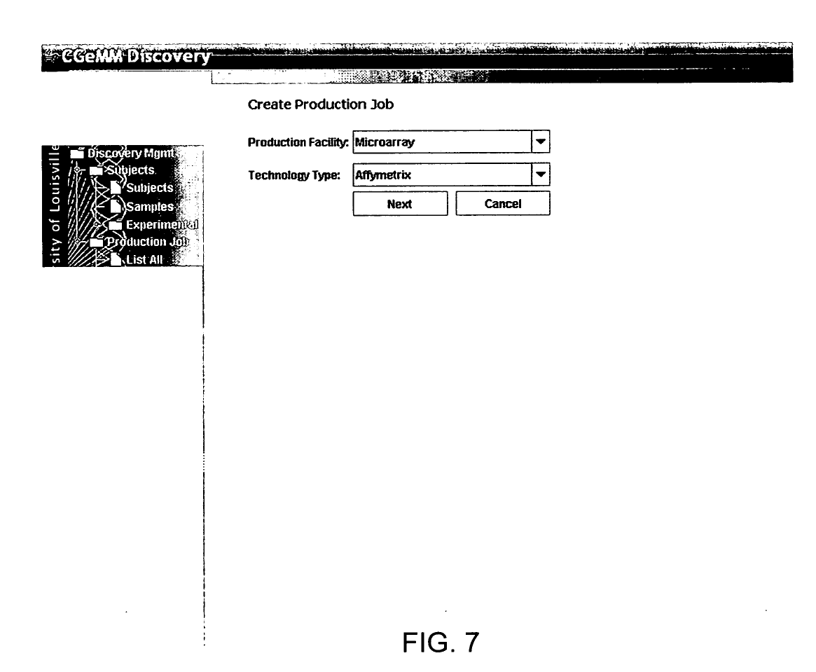

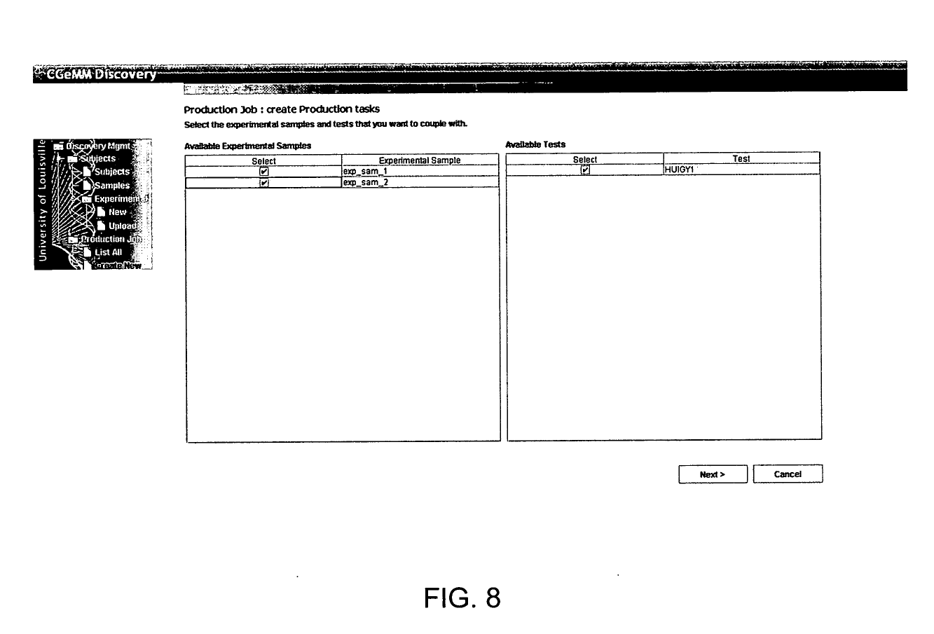

Once experimental samples have been entered/selected, the researcher can create what is referred to as a production job. The production job is a collection of production tasks, and makes it possible to organize the individual experimental sample/test pairings (production tasks) into a larger, more comprehensive experiment. In the example shown in FIG. 7, an Affymetrix chip based production job is being created for submission to the “Microarray” production core. Once the production job is created, the interface shown in FIG. 8 can be used to couple experimental samples with tests, in this case an Affymetrix microarray. In the example embodiment, available production samples and relevant available tests are presented in tables and the user can associate one or multiple samples with one or multiple tests.

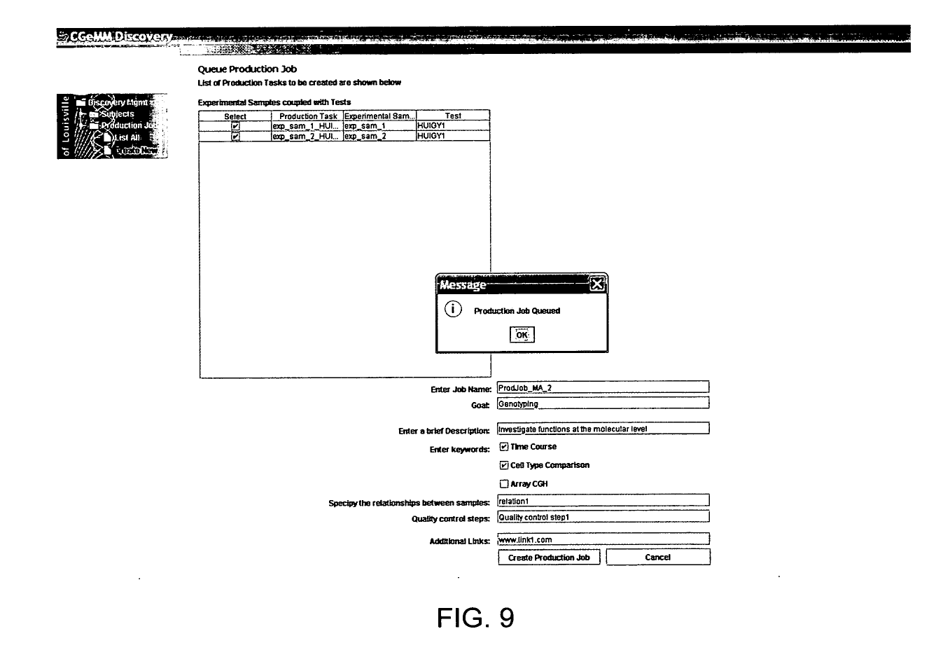

Once created, the production job can be queued to the specified service provider, as seen in FIG. 9 In the example shown in FIG. 9, the service provider is a microarray facility. The interface shown provides fields for entering a job name, a job goal, a brief description, relationships between samples, quality control steps, and additional links. There is also a key word selection field in the interface shown in FIG. 9.

The server 16 also preferably provides an interface for companies that provide software for analyzing life sciences data, SAS and the like, permitting companies to design application programming interfaces for researchers to interoperate with the provider's system. In an example embodiment, an application programming interface is provided by the server 16 to researchers. An example embodiment is provided using the R programming language, which permits researchers to perform industry standard analysis on their data using the R tools with which they are familiar. The SSOAP package has been used for the purpose of interoperation between the Discovery System and the R.

A typical R session is illustrated:

>library(SSOAP);
>adef = processWSDL(“http://cgemm.louisville.edu/cgemm/services/
DiscoveryServices?wsdl”)
>aiface = genSOAPClientInterface(adef@operations[[1]], adef,
adef@name)
>token = aiface@functions$login(“kalbflei”, <kalbfleiPwd>);
>Data<- ReadAffy(aiface@functions$getCELFile(token,
<productionTaskId>))

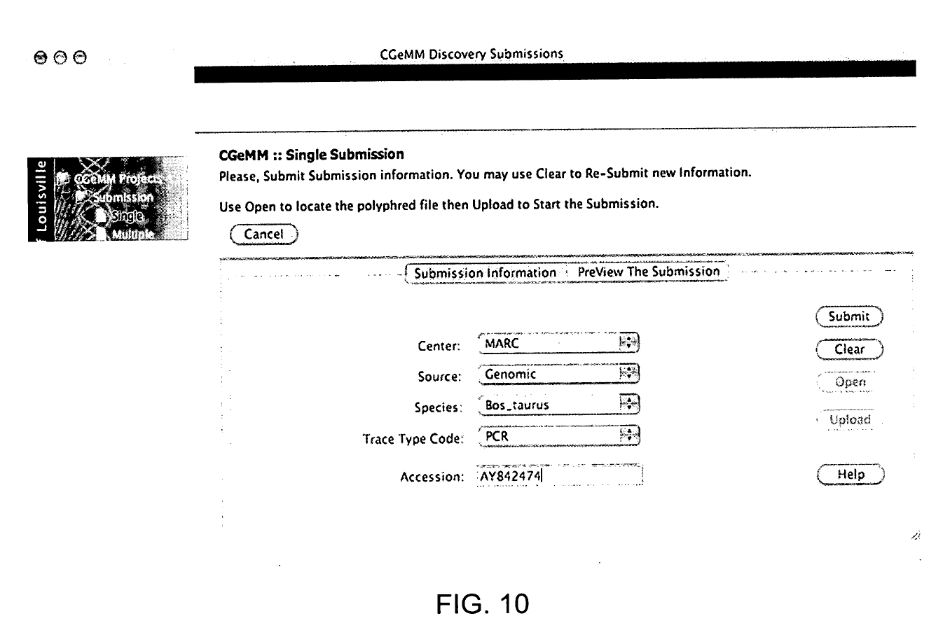

The database 18 also provides a repository for the data that is generated by a service provider, integrating the data with the other data available to the researcher in the discovery system of FIG. 1. FIG. 10 shows a user interface for a provider to upload single nucleotide polymorphism and genotype data produced in a resequencing experiment to the server 16 for integration into the larger dataset of information available to requesting researchers. Selection menus or data entry fields are provided for center (particular provider), source, species, trace type code, and an accession number. Once the data has been imported, it is accessible with all other complementary data that is available to the researcher.

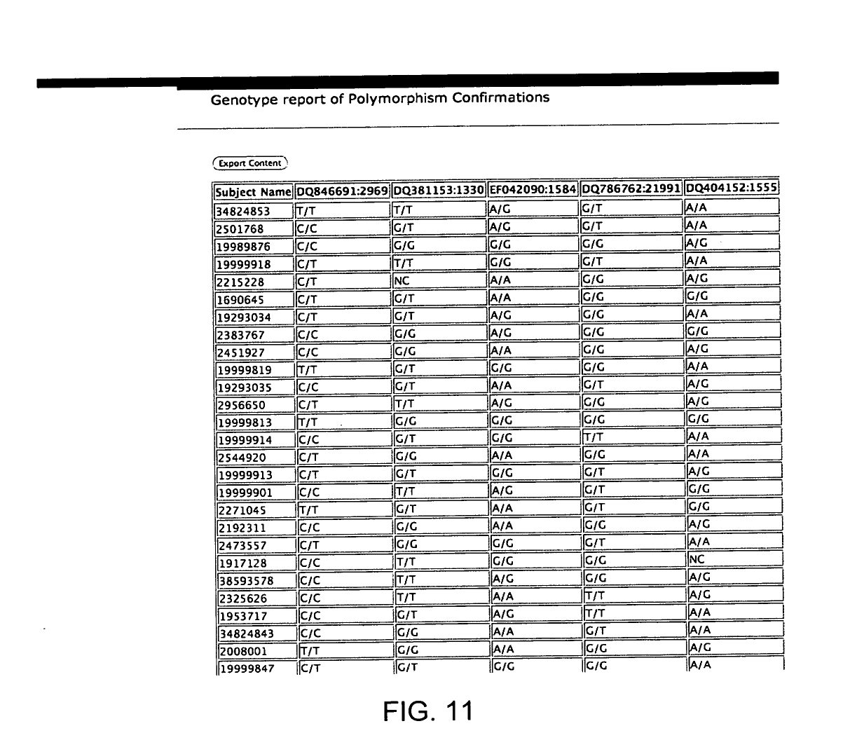

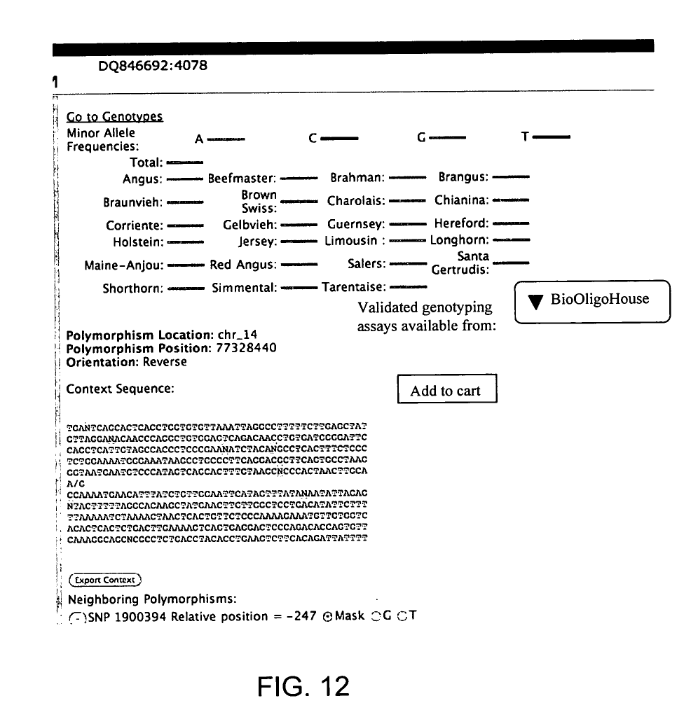

As shown in FIG. 11, the database 18 also provides an interface to for users who have uploaded genotype data to view those genotypes in the context of other information available within the system. The server 16 makes use of available tools to link assays available from reagent vendors with data submitted by researchers. For example, the interface shown in FIG. 12 informs the researcher that BioOligoHouse has existing validated assays for this polymorphism, and that they may be ordered through the system. The assay vendor may submit assays to the system as described above, such that they can be mapped to or associated with existing SNP records, for example, and researchers will be able to view which SNPs have assays available to them, as seen in FIG. 12.

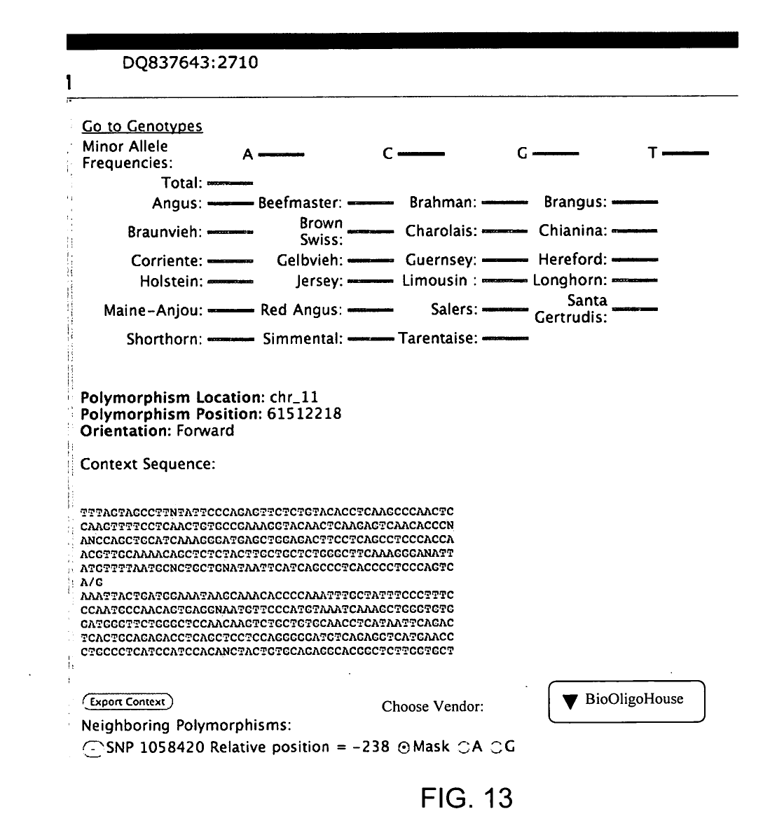

Similarly, the server 16 provides an interface for companies that provide assay synthesis services such that any assay that is designed within the system can be submitted directly for synthesis. FIG. 13 shows an interface presented through the browser 12 that allows a researcher to view the context sequence neighboring a single nucleotide polymorphism of interest. This interface provides the researcher the opportunity to mask neighboring polymorphisms if the minor allele frequency is high enough (gray shading), and to choose the major allele if the minor allele frequency is zero, or near zero in their population (colored background). This data can be exported to a custom oligonucleotide synthesis shop for assay design and validation.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. Software providing an interface to an interoperable public and proprietary accessible database and data brokerage server, the software comprising code for:
presenting a graphical user interface to a researcher, the interface including menus, screens and/or fields for accepting life sciences researcher data, permitting the researcher to grant permissions for others to access the data, viewing third party data relating to the researcher data, and viewing and ordering provider services and/or products related to the researcher data;
loading researcher data from a researcher computer to the server;
securing the researcher data stored in the database according to grant permissions of the researcher;
presenting the third party data relating to the researcher data; and
presenting provider services and/or products related to the researcher data.

2. The software of claim 1, wherein the code for securing permits the researcher to grant row and role level access to data.

3. The software of claim 1, wherein the third party data comprises data available within the public domain.

4. The software of claim 3, wherein the third party data further comprises data available from a provider.

5. The software of claim 1, wherein the researcher data comprises single nucleotide polymorphism data.

6. The software of claim 5, wherein software fuirther comprise code for mapping, via sequence, similarity between the single nucleotide polymorphism data to single nucleotide polymorphisms datasets available to the server.

7. The software of claim 6, wherein when a match is found between the single nucleotide polymorphism data and data in the datasets available to the server then an association is created therebetween by the server, and if no match is found, then new single nucleotide polymorphism data is created in the system.

8. The software of claim 1, wherein the interface further includes menus, screens and/or fields for accepting samples and for coupling samples with tests to create experiments, and to queue experiments for a service provider, and the server provides the experiments to a service provider and brokers information exchange and payment between the service provider and the researcher.

9. The software of claim 8, wherein samples can be pooled and coupled to a test to create an experiment.

10. The software of claim 1, further comprising code for presenting an interface to a provider to permit the provider to upload provider data.

11. The software of claim 10, wherein the interface to a provider permits a reagent vendor to submit assays to be mapped by the server so that a researcher can view assays relevant to the researcher data.

12. The software of claim 10, wherein the interface to a provider permits an assay synthesis service to offer, via the server, an interface for a researcher to design an assay and submit it for synthesis to the assay synthesis service.

13. The software of claim 1, further comprising code for permitting providers to install application programming interfaces for use by researchers to interact with the provider.

14. A system for facilitating comprehensive, collaborative research in the life sciences, the system including:
a repository permitting a researcher to securely store and share data such that it will be integrated with data available within the public domain and can be viewed by any collaborating researcher with appropriate permissions;
security means for allowing the researcher to grant access permissions to collaborating researchers;
a brokerage service between the researcher and participating product and/or service providers;
an interface to allow the researcher to enter samples, to couple them with known tests, and queue these experimental projects to the service provider; and
a repository for the provider data that is generated by the participating service and/or service providers, integrating the provider data with other data available to the researcher in the system.

15. The system of claim 14, wherein the system further includes:
an interface to permit reagent vendors to submit assays to be mapped within the system as part of the provider data, so that when a researcher looks at features of interest, the researcher will be able to see what assays may be available for order. and
an interface to permit assay synthesis services to provide the researcher the ability to design an assay be submitted to the assay synthesis service for synthesis.

16. The system of claim 15, wherein the system further comprise an interface for companies that provide analysis tools to design application programming interfaces to interoperate with the system.
